(19) United States
(12) Patent Application Publication
(10) Pub. No.: US 2015/0309185 A1
(43) Pub. Date: Oct. 29, 2015

(54) EXTREMITY RADIATION MONITORING SYSTEMS AND RELATED METHODS

(71) Applicant: Battelle Energy Alliance, LLC, Idaho Falls, ID (US)

(72) Inventors: David L. Chichester, Idaho Falls, ID (US); Scott M. Watson, Idaho Falls, ID (US); Madelyn R. Wolter, Hartford, WI (US)

(73) Assignee: Battelle Energy Alliance, LLC, Idaho Falls, ID (US)

(21) Appl. No.: 14/265,206

(22) Filed: Apr. 29, 2014

(51) Int. Cl. G01T 1/02; G01T 7/12

(52) U.S. Cl. CPC G01T 1/023; G01T 7/12

(57) ABSTRACT

Systems and methods of monitoring radiation include a radiation monitoring glove. The glove is to be worn by a person that may be exposed to the radiation and includes at least one fiber sleeve attached to at least one finger of the glove. The glove also includes at least one scintillating fiber disposed in the at least one fiber sleeve. The scintillating fiber is configured for generating photons responsive to exposure to radiation in proximity thereto. The glove also includes a photon-sensing device disposed in a collector pocket on the glove. The photon-sensing device is operably coupled to a distal end of the one or more scintillating fibers.

### STATEMENT REGARDING FEDERALLY SPONSORED RESEARCH OR DEVELOPMENT

This invention was made with government support under Contract No. DE-AC07-05ID14517 awarded by the United States Department of Energy. The government has certain rights in the invention.

### TECHNICAL FIELD

Embodiments of the present disclosure are directed to methods, systems, and apparatus for sensing radiation. More particularly, embodiments of the present disclosure relate to using scintillating fibers to monitor radiation dosage and dose rates to an extremity of a person, instrument, or device.

### BACKGROUND

People that use their hands to work with highly-radioactive sources have the potential to receive large exposures of ionizing radiation to their hands, especially their fingers. Workers in this category include glove-box technicians, scientists preparing metallurgical samples, and radio-pharmacists and nurses preparing radiological solutions for injection into patients. Today, these people use passive finger dosimeters to assess radiological exposures.

There are currently several methods being proposed for active extremity dose monitoring. One is a reusable fingertip extremity dosimeter. This device slips over the entire finger, with the active element at the tip of the finger. It uses a thin layer of TLD-700H powder, placed on a Kapton® substrate, to achieve good responses to photons and beta particles. This device can be read and reused up to 50 times.

Another type of detector being examined is centered on silicon diodes. These prototypes have been put to use but only as a single detector. The goal of this detector was to monitor the dose to the pad of the fingers. In order not to impose on the work being performed, the dosimeter was placed on the fingernail. It was found that this detector was able to record dose, but the dose to the finger pad was 8.7 times larger than the dose recorded by the detector on the fingernail.

An additional method uses optically stimulated luminescent (OSL) radiation dosimetry. Devices using this method may be small, have low power consumption, high sensitivity, and a wide range for measurements. They can be easily used to monitor remote locations as well as hazardous locations. An optical fiber sits inside a plastic tube with a CaS:Ce,Sm dosimeter at the end. Stimulating light hits the CaS:Ce,Sm scintillating material and the resulting, different-wavelength light travels up the optical fiber. The OSL film and optical fiber are coupled together as a dosimeter probe.

There is a need for real-time dosimetry monitoring for extremities that can be performed by systems that are worn in a manner that does not significantly impede the work performed by technical personnel and gives substantially real-time analysis and warnings of large exposures to ionizing radiation of the extremities.

### BRIEF SUMMARY

Embodiments of the present disclosure include methods and systems for dosimetry monitoring of extremities that can be worn on the extremities in a manner that does not significantly impede the work performed by technical personnel and gives quasi real-time analysis and warnings of large exposures to ionizing radiation of the extremities.

Embodiments of the present disclosure include a radiation monitoring system including one or more scintillating fibers for generating photons responsive to exposure to radiation in proximity to one or more of a length and a proximate end of the one or more scintillating fibers. A photon-sensing device is operably coupled to a distal end of each of the one or more scintillating fibers and is for sensing photons from the one or more scintillating fibers. An extremity protection device includes one or more individual fiber sleeves, each individual fiber sleeve for holding a corresponding one of the one or more scintillating fibers substantially close to an extremity. The glove also includes a collector pocket for holding the photon-sensing device on an arm of the person.

Embodiments of the present disclosure include a method of monitoring a radiation. The method includes sensing radiation proximate a glove on a hand of a person with one or more scintillating fibers held by one or more individual fiber sleeves, each individual fiber sleeve disposed on a corresponding finger of the glove. The method also includes generating photons responsive to the one or more scintillating fibers exposure to the radiation and generating an electrical signal with a photon-sensing device held on a forearm portion of the glove responsive to the sensed photons. A radiation dose level is evaluated responsive to the electrical signal.

Embodiments of the present disclosure include a radiation monitoring glove that includes a glove adapted to be worn by a person and one or more fiber sleeves attached to one or more fingers of the glove. The radiation monitoring glove also includes one or more scintillating fibers disposed at least in part in the one or more fiber sleeves. The one or more scintillating fibers are configured for generating photons responsive to exposure to radiation in proximity thereto. The radiation monitoring glove also includes a photon-sensing device disposed in a collector pocket on the glove and operably coupled to a distal end of the one or more scintillating fibers.

### BRIEF DESCRIPTION OF THE DRAWINGS

FIG. 1A is a block diagram illustrating some elements of a real-time radiation dose monitoring system.

FIG. 1B is a block diagram showing details of a photon-sensing device and a photon signal analyzer.

FIG. 1C is a block diagram showing details of a computing system.

FIG. 2 shows a physical depiction of a scintillating fiber.

FIG. 3 illustrates a glove for holding at least some of the elements of the real-time radiation dose monitoring system.

FIGS. 4A and 4B are spectra-graphs showing experimental results for sampling a ²²Na source with a BCF-10 scintillating fiber.

FIGS. 5A and 5B are spectra-graphs showing experimental results for sampling a ¹³⁷Cs source with a BCF-10 scintillating fiber.

FIGS. 6A and 6B are spectra-graphs showing experimental results for sampling a ⁶⁰Co source with a BCF-10 scintillating fiber.

FIGS. 7A and 7B are spectra-graphs showing experimental results for sampling a ²²Na source with a BCF-12 scintillating fiber.

FIGS. 8A and 8B are spectra-graphs showing experimental results for sampling a ¹³⁷Cs source with a BCF-12 scintillating fiber.

FIGS. 9A and 9B are spectra-graphs showing experimental results for sampling a ⁶⁰Co source with a BCF-12 scintillating fiber.

FIGS. 10A through 10D illustrate an experimental test jig for holding a scintillating fiber at various curvatures while sampling a radiation source.

FIG. 11 shows a graph of background corrected averages with standard deviation as a function of distance from a photon-sensing device.

FIG. 12 shows a graph of all of the background corrected averages with standard deviation as a function of distance from the photon-sensing device from a second round of tests.

FIG. 13 illustrates normalized data from a third round of tests on a straight scintillating fiber.

### DETAILED DESCRIPTION

The illustrations presented herein may not be actual views of any particular material, device, apparatus, assembly, system, or method, but are merely idealized representations that are employed to describe embodiments of the present disclosure. Additionally, elements common between figures may retain the same numerical designation for convenience and clarity.

Furthermore, specific implementations shown and described are only examples and should not be construed as the only way to implement or partition the present disclosure into functional elements unless specified otherwise herein. It will be readily apparent to one of ordinary skill in the art that the various embodiments of the present disclosure may be practiced by numerous other partitioning solutions.

In the following description, elements, circuits, modules, and functions may be shown in block diagram form in order not to obscure the present disclosure in unnecessary detail. Moreover, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. For example, data, instructions, commands, information, signals, bits, symbols, and chips that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus for carrying the signals, wherein the bus may have a variety of bit widths.

The various illustrative logical blocks, modules, and circuits described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor is configured to execute instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

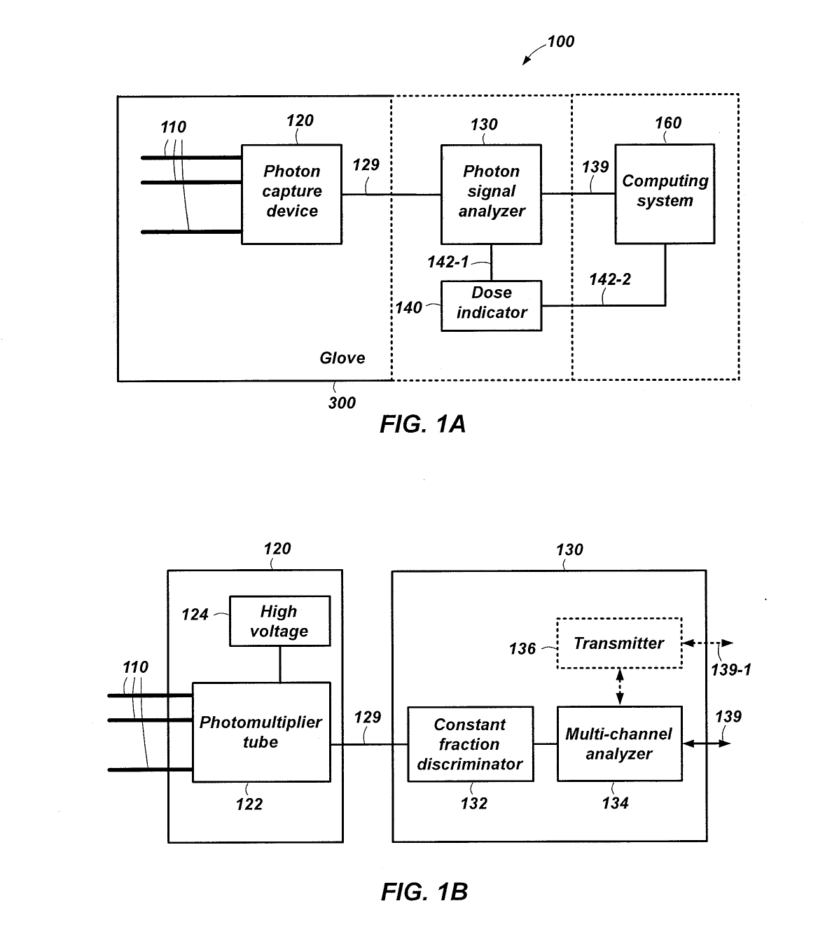

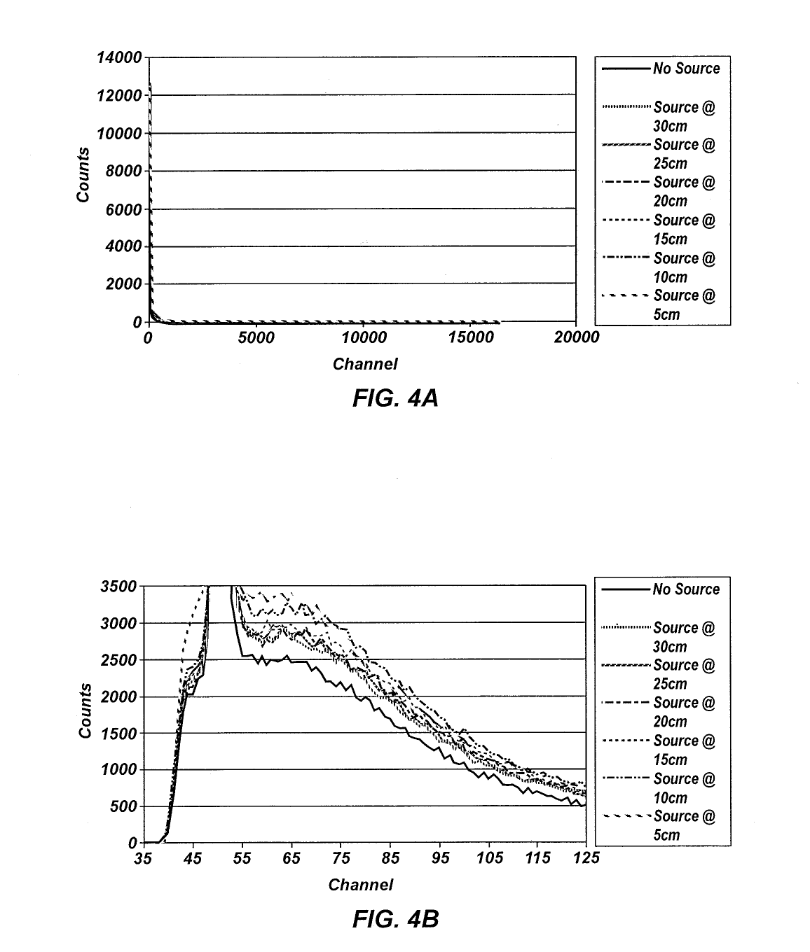

It should be understood that any reference to an element herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. Thus, for example, element identifiers on a FIG. 1 will be mostly in the numerical format 1xx and elements on a FIG. 4 will be mostly in the numerical format 4xx.

Embodiments of the present disclosure include methods and systems for dosimetry monitoring of extremities that can be worn on the extremities in a manner that does not significantly impede the work done by a wearer of the system or a portion thereof and gives substantially real-time analysis and warnings of large exposures to ionizing radiation of the extremities.

Most of the description herein focuses on gloves that a person can wear as a type of extremity protection device. However, embodiments of the present disclosure may also include other types of extremity protection devices including scintillating fibers that can be worn by a person. As non-limiting examples, personnel might use similar sensors on the forearms, legs, feet, head, or combinations thereof. For example, workers operating at a former nuclear facility that is being decommissioned. Also, emergency response workers working a in a flooded compartment, such as at Fukushima where strontium in water could contribute to high dose to feet standing in contaminated water; especially if something stirs up the water. In addition, these extremity cover devices may also be used for instruments and mechanical extremities of devices such as robotic devices.

Personnel working with high-dose-rate radiation samples can receive high ionizing radiation doses to their hands. To analyze this problem, embodiments of the present disclosure use scintillating fibers included in dosimetry gloves to be worn by operators. These scintillating fibers begin at the tips of the fingers and travel up the arm and connect to a photon-sensing device located on a forearm portion of the glove. In some embodiments, wires connect to electronics equipment to further analyze the radiation dose. In other embodiments, the information from the photon-sensing device may be transmitted wirelessly to remote electronic equipment. This radiation dose monitoring system will monitor the dose and dose rate received by the workers and warn them of high dose rates and high cumulative hand exposures. This information might also be monitored by a technician or manager to gauge the progress on the activity and maintain situational awareness while the operator is working. Sometimes people become too focused or distracted to notice their own alarms.

FIG. 1A is a block diagram illustrating some elements of a real-time radiation dose monitoring system. One or more scintillating fibers 110 are coupled to a photon-sensing device 120, which is coupled to a photon signal analyzer 130, which may be coupled to a computing system 160.

Ionizing radiation interacts with the material inside the scintillating fibers 110. The excited atoms in the scintillator material relax to a lower energy state, emitting light photons. The emission of light may be an inefficient process in pure inorganic scintillator crystals, and the photons may be too high in energy to lie in the range of wavelengths seen by a photon-sensing device 120. To overcome this limitation, impurities known as activators may be added to the scintillator material to enhance the emission of visible photons. These activators may also be used on organic scintillators.

The visible photons incident on the photon-sensing device 120 liberate electrons through a photoelectric effect to generate an electrical signal 129. The electrical signal 129 can be analyzed by the photon signal analyzer 130, and possibly the computing system 160, to determine substantially instantaneous radiation dose levels as well as cumulative radiation dosage. The results of these determinations may be sent via a dose signal 142 to a dose indicator 140. As used herein the dose signal 142 may be used to convey and indicate many types of general dosage such as, for example, quasi instantaneous dose rates, dose rate, cumulative dosage, total dosage, average dosage and other indicators that may be computed relative to the dose signal.

The dose indicator 140 may be any indicator perceivable by a person working with the high-dose-rate radiation sample. As a non-limiting example, the dose indicator 140 may be as simple as an audio generator such as a speaker or a Light Emitting Diode (LED) for generating a light. As other non-limiting examples, the dose indicator 140 may include multiple LEDs for indicate relative dose levels or cumulative dosage, for example, in a bar graph arrangement. In still other non-limiting examples, the dose indicator 140 could be a display device that can give more complex information such as graphs and readouts to the operator. Still other dose indicators 140 may include a tactile indicator such as a vibrator at a position where the operator could perceive the tactile feedback.

The scintillating fibers 110 and photon-sensing device 120 may be disposed in a glove 300 to be worn by a person working with the high-dose-rate radiation sample. In some embodiments, one or more of the dose indicator 140, the photon signal analyzer 130, and the computing system 160 may also be located in the glove 300.

The photon-sensing device 120 may be any device suitable for converting photons generated by the scintillating fibers 110 into the electrical signal 129. As non-limiting examples, the photon-sensing device 120 may include one or more photodiodes or a photomultiplier tube 122.

FIG. 1B is a block diagram showing details of a photon-sensing device 120 using a photomultiplier tube 122 and a photon signal analyzer 130. A high voltage generator 124 may be included to generate any voltages necessary for proper operation of the photomultiplier tube 122. Photons impinging on the photocathode of the photomultiplier tube 122 liberate electrons through the photoelectric effect. These photoelectrons are accelerated through the photomultiplier tube 122 by a strong electric field and collide with electrodes in the tube, which release additional electrons. The increased electron flux colliding with succeeding electrodes causes a multiplication of the electron flux by a factor of 10⁴ or more. The amplified charge is proportional to the initial amount of charge liberated at the photocathode of the photomultiplier tube 122, which is proportional to the amount of light incident on the photomultiplier tube 122, which, in turn, is proportional to the amount of energy deposited in the scintillating fibers 110.

In some embodiments, such as, for example, embodiments using photodiodes using lower voltages, there may be no need for a high voltage generator 124.

In some embodiments, the photon signal analyzer 130 may be a relatively simple electronic device capable of generating a simple dose signal 142-1 for the dose indicator 140 to the operator. In such an embodiment, the electrical signal 129 may be analyzed for signal pulse rate, voltage amplitude, current amplitude, or other suitable electrical characteristic indicative of the number of photons generated by the scintillating fibers 110.

In other embodiments, the photon signal analyzer 130 may be more complex. Such an embodiments is illustrated in FIG. 1B as one example of a more complex photon signal analyzer 130. The electrical signal 129 from the photomultiplier tube 122 is received by a discriminator 132. In some embodiments, the discriminator may be configured as a constant fraction discriminator 132. The constant fraction discriminator 132 may be used to develop accurate timing information from the electrical signal 129 by triggering a timing signal at a constant fraction of the input amplitude on the electrical signal 129. In general, it has been observed that leading edge timing of a signal has an optimum value at a particular fraction of the amplitude of the signal, such as, for example, about 10 to 15 percent. The constant fraction discriminator 132 can set this fractional value at which to trigger a signal to reduce timing differences between signals with similar rise times, but different amplitudes.

The output of the discriminator 132 may be input to a multi-channel analyzer 134. The multi-channel analyzer 134, in its simplest form, analyzes a stream of voltage pulses and sorts them into a histogram or “spectrum” of number of events versus pulse-height, which may often relate to energy or time of arrival. The resulting spectrum may be stored or sent as an analysis signal 139 to the computing system 160 for further analysis. Various spectra from a multi-channel analyzer 134 are illustrated in the experimental results discussed below. In addition, the multi-channel analyzer 134 may analyze the spectrum to generate the dose signal 142 for the dose indicator 140.

In some embodiments the photon signal analyzer 130 may include a transmitter 136 for transmitting the analysis signal 139-1 as a wireless signal to the computing system 160 such that the computing system 160 may be positioned remotely from the photon signal analyzer 130. Some examples of suitable wireless signals are discussed below. Of course, the transmitter 136 may be a transceiver such that signals from the computing system 160 may be received at the photon signal analyzer 130. Such signals may include setup information and results of analysis performed by the computing system 160 that may be used to, directly or indirectly, generate the dose signal 142. Similarly, the analysis signal 139 may be bidirectional to communicate the same type of information from the computing system 160 to the photon signal analyzer 130.

FIG. 1C is a block diagram showing details of a computing system 160 that may be included for practicing embodiments of the present disclosure. Computer, computing system, and signal processor may be used interchangeably herein to indicate a system for practicing some embodiments of the present disclosure. The computing system 160 is configured for executing software programs containing computing instructions and includes one or more processors 162 and memory 164. The computing system 160 may also include storage 166, user interface elements 168, and one or more communication elements 170.

As non-limiting examples, the computing system 160 may be a user-type computer, a file server, a compute server, a notebook computer, a tablet, a handheld device, a mobile device, or other similar computer system for executing software. Moreover, the multi-channel analyzer 134 may be configured as a computing system 160.

The one or more processors 162 may be configured for executing a wide variety of operating systems and applications including the computing instructions for carrying out embodiments of the present disclosure.

The memory 164 may be used to hold computing instructions, data, and other information for performing a wide variety of tasks including performing embodiments of the present disclosure. By way of example, and not limitation, the memory 164 may include Synchronous Random Access Memory (SRAM), Dynamic RAM (DRAM), Read-Only Memory (ROM), Flash memory, and the like.

Information related to the computing system 160 may be presented to, and received from, a user with one or more user interface elements 168. As non-limiting examples, the user interface elements 168 may include elements such as displays, keyboards, mice, joysticks, haptic devices, microphones, speakers, cameras, and touchscreens. A display on the computing system 160 may be configured to present a graphical user interface (GUI) with information about some embodiments of the present disclosure, as is explained below.

The communication elements 170 may be configured for communicating with other devices or communication networks, such as, for example, the photon signal analyzer 130 (FIG. 1A). As non-limiting examples, the communication elements 170 may include elements for communicating on wired and wireless communication media, such as, for example, serial ports, parallel ports, Ethernet connections, universal serial bus (USB) connections IEEE 1394 (“firewire”) connections, BLUETOOTH® wireless connections, 802.1 a/b/g/n type wireless connections, and other suitable communication interfaces and protocols.

The storage 166 may be used for storing relatively large amounts of non-volatile information for use in the computing system 160 and may be configured as one or more storage devices. By way of example, and not limitation, these storage devices may include computer-readable media (CRM). This CRM may include, but is not limited to, magnetic and optical storage devices such as disk drives, magnetic tapes, CDs (compact discs), DVDs (digital versatile discs or digital video discs), and other equivalent storage devices.

Software processes illustrated herein are intended to illustrate representative processes that may be performed by the systems illustrated herein. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many steps and processes may occur in addition to those outlined in flowcharts. Furthermore, the processes may be implemented in any suitable hardware, software, firmware, or combinations thereof.

When executed as firmware or software, the instructions for performing the processes may be stored on a computer-readable medium. A computer-readable medium includes, but is not limited to, magnetic and optical storage devices such as disk drives, magnetic tape, CDs (compact discs), DVDs (digital versatile discs or digital video discs), and semiconductor devices such as RAM, DRAM, ROM, EPROM, and Flash memory.

By way of non-limiting example, computing instructions for performing the processes may be stored on the storage 166, transferred to the memory 164 for execution, and executed by the processors 162. The processors 162, when executing computing instructions configured for performing the processes, constitute structure for performing the processes and can be considered a special-purpose computer when so configured. In addition, some or all portions of the processes may be performed by hardware specifically configured for carrying out the processes.

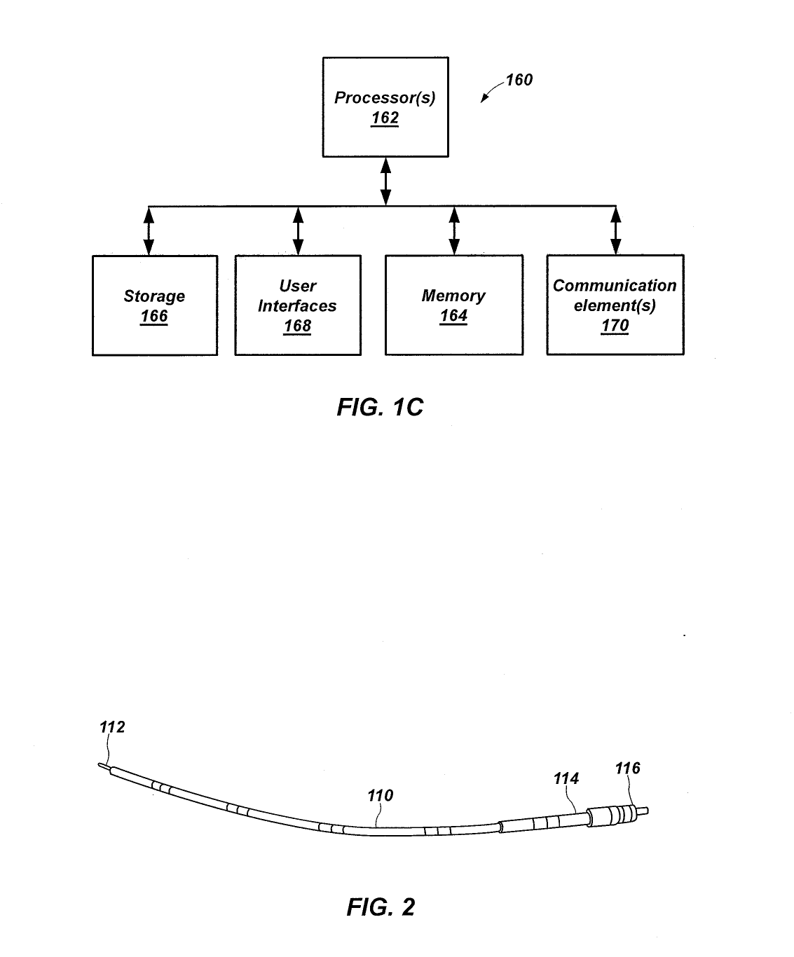

FIG. 2 shows a physical depiction of a scintillating fiber 110. The scintillating fiber 110 includes a proximate end 112, which will be positioned near a fingertip of a glove as discussed below and a distal end 114, which will be used to couple to the photon signal analyzer 130 (FIG. 1A). For ease of connection, a suitable connector may be included on the distal end 114, such as, for example, the SMA connector 116 illustrated.

The scintillating fiber 110 may be any suitable fiber for practicing embodiments as discussed herein. As non-limiting examples, experimental details are discussed below for BCF-10 1-mm diameter fiber and BCF-12 0.250-mm fiber.

Also referring to FIG. 1A, in some embodiments, distal ends 112 of multiple scintillating fibers 110 may be grouped into one SMA connecter 116. This enables the use of just one photon sensing device 120. In other embodiments, there may be a photon sensing device 120 for each scintillating fiber 110 or groups of scintillating fibers 110. As a non-limiting example, some of the fingers may include multiple scintillating fibers 110 terminating in a single SMA connector 116 such that the photons from both scintillating fibers 110 related to that finger may be analyzed together. A person of ordinary skill in the art will understand that there may be many combinations of fibers that can be analyzed individually or grouped in various combinations.

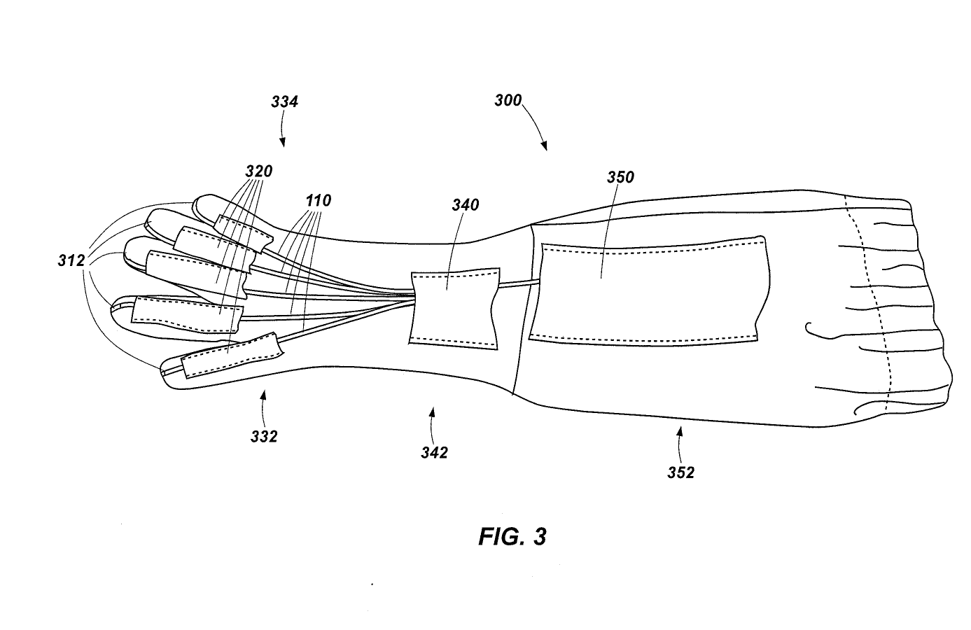

FIG. 3 illustrates a glove 300 for holding at least some of the elements of the radiation dose monitoring system 100 illustrated in FIG. 1A. The term “finger” is used herein to refer generically to the fingers and thumb of a hand, a glove 300, or a combination thereof. The glove 300 includes five fingers, a wrist portion 342, and a forearm portion 352. The glove 300 may also be referred to as having a palm side 334 and a back-of-hand side 332. The glove 300 may also be referred to herein as a radiation does monitoring glove 300.

Referring to FIGS. 2 and 3, a scintillating fiber 110 may be included for each finger of the glove 300. Of course, other configurations of gloves 300 with fewer scintillating fibers 110, and fewer fingers may be used. In addition, multiple scintillating fibers 110 may be used in one or more fingers of the glove 300 and scintillating fibers 110 may be positioned in other places on the glove such as the palm, back of hand, wrist, and forearm.

The glove 300 includes fiber sleeves 320 for holding the scintillating fibers 110 near the fingers and the fingertips 312 of the glove 300. In some embodiments, the fiber sleeves 320 may be configured to hold the scintillating fibers 110 on the palm side 334 of the glove 300. In other embodiments, the fiber sleeves 320 may be configured to hold the scintillating fibers 110 on the back-of-hand side 332 of the glove 300. In still other embodiments, the fiber sleeves 320 may be configured to hold the scintillating fibers 110 on the sides of the fingers.

In some embodiments the fiber sleeves 320 may be open or disconnected at various positions, such as, for example, knuckles or wrists such that they are adapted and positioned to enable the one or more scintillating fibers 110 to slide freely therein as the one or more fingers of the glove move.

In some embodiments, the fiber sleeves 320 may run up the glove to a collector pocket 350 on the forearm portion 352 of the glove 300. In other embodiments, such as is shown in FIG. 3, the fiber sleeves 320 may only be present on the fingers of the glove 300. In such embodiments, a fiber collector 340 may be included on a hand portion of the glove 300 or on the wrist portion 342. As with the fiber sleeves 320, the fiber collector 340 and collector pocket 350 may be positioned on the palm side 334 or the back-of-hand side 332 of the glove 300.

In the illustrated embodiment, the collector pocket 350 is shown on the forearm portion 352 of the glove. However, other embodiments may include the collector pocket at other locations such as, for example, the torso, back, waist, or upper arm.

The fiber collector 340 is configured to hold the photon-sensing device 120 (FIG. 1A) and its connections to each of the scintillating fibers 110. In some embodiments, the photon signal analyzer 130, the computing system 160, or a combination thereof may also be positioned in the fiber collector 340.

The arrangement of the scintillating fibers 110 within the fiber sleeves 320 and with a connector such as the SMA connector 116 (FIG. 2) enables adaptation and customization. As non-limiting examples, The scintillating fibers 110 may be disposable, so if contaminated or damaged they may be replaced using quick disconnects (e.g., the SMA connector 116). In addition, different lengths of scintillating fibers 110 may be chosen to have a custom fit for people of different sizes with different sized hands.

The scintillating fibers 110 may be covered with any suitable light-opaque covering, such as, for example, black shrink wrap, to cover the length of the fiber, the proximate end 114, and the connection of the scintillating fibers 110 to any connector used at the distal end 112. The black shrink wrap ensures that there is little or no light leakage from the fiber so all the photons exit the scintillating fibers 110 at the distal end 112 to be sampled by the photon-sensing device 120.

In some embodiments, the ends of these black shrink wrap pieces may include a longer crimped end that can be sewn around the tips of the fingers onto the finger pads. This may help hold the scintillating fibers 110 in place with the proximate end 114 of the scintillating fibers 110 at the fingertip 312 of the glove 300.

In order to evaluate the effectiveness of the active dosimetry glove 300, several experimental analysis procedures were used. Referring to FIG. 1A, much of the experimental analysis discussed below may be performed by the photon signal analyzer 130, the computing system 160, or combinations thereof to determine the dose signal 142 and presenting a dose indicator 140 to an operator.

Single fibers were tested to determine what types of scintillating fibers 110 may be useful. Dose measurements were taken for several sources to determine conversion factors between counts and dose. Of course, a person of ordinary skill in the art will understand that much of the discussion below is related to a specific experimental configuration. The person of ordinary skill in the art will also understand that changes and adaptations may be made when embodying the elements and analysis in the active dosimetry glove 300.

Two types of scintillating fibers 110 were tested; 1-mm diameter BCF-10 and 0.250-mm diameter BCF-12. The fibers were terminated, a spectrum of each fiber was obtained, and then gross-area counts were taken for both fibers with different bend diameters.

The scintillating fiber 110 was cut to about 31 cm. A clear plastic tube was also cut to the same length. The scintillating fiber 110 was placed inside the clear plastic tube, and then a black shrink-wrap cover was added over the clear tube. One end of the fiber was fully terminated in an SMA connector. The other end was polished flat and coated with epoxy. Finally, the scintillating fiber 110 was marked at 5-cm increments originating from the SMA-terminated end.

For these experiments, three sources were used: sodium-22 (²²Na), cesium-137 (¹³⁷Cs), and combalt-60 (⁶⁰Co). The source was positioned on top of the scintillating fiber 110 facing downward, centered over the fiber. A small gap was left between the fiber and the surface of a lead sheet covering most of the source. This gap was used to ensure that the distance between the source and scintillating fiber 110 remained constant during all tests, even when tools were used to curve the scintillating fiber 110 in later tests.

Pulse-height spectra were obtained for both the BCF-10 and BCF-12 scintillating fibers 110 using the three sources. For these spectra, the scintillating fibers 110 were fixed straight, and several spectrum counts were taken using 900.00-sec count times. First, a spectrum was taken with no source present to represent the background environment. Then, for each source, the source was moved down the length of the scintillating fiber from 30 cm to 25 cm, 20 cm, 15 cm, 10 cm, and 5 cm. New counts were taken with the source in each location.

FIGS. 4A and 4B are spectra-graphs showing experimental results for sampling a ²²Na source with a BCF-10 scintillating fiber 110. Each line in the spectra illustrates counts for a different location along the scintillating fiber 110. FIG. 4A illustrates the full spectrum from zero to 20,000 while FIG. 4B illustrates a portion of the spectrum from channels 35 to 125.

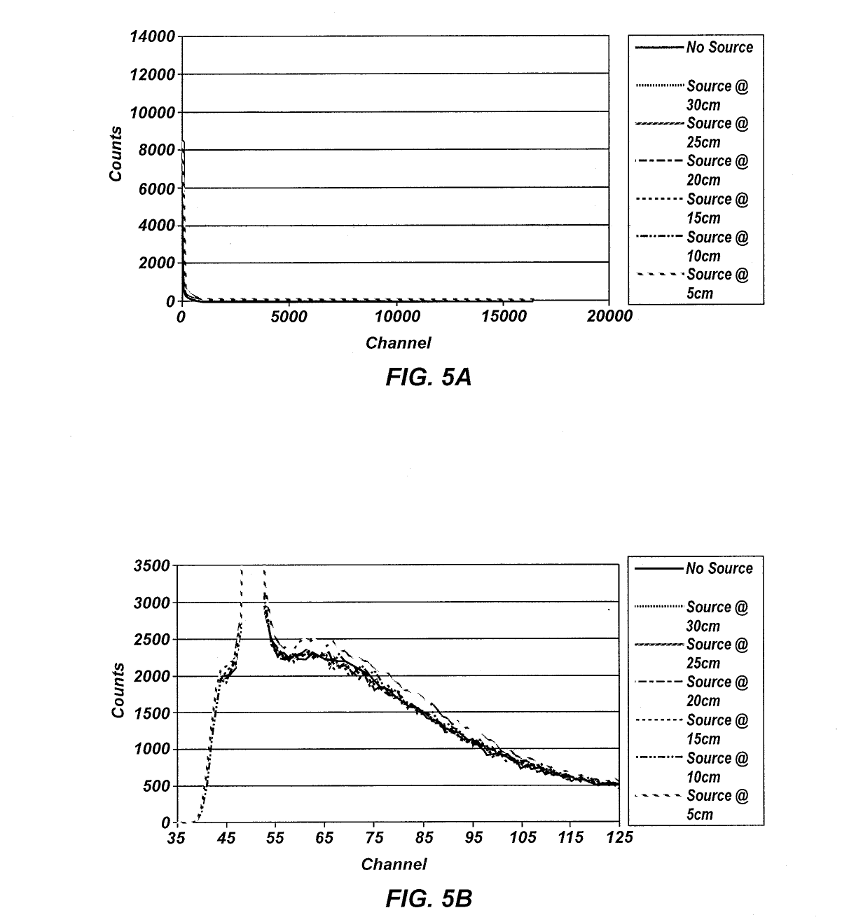

FIGS. 5A and 5B are spectra-graphs showing experimental results for sampling a ¹³⁷Cs source with a BCF-10 scintillating fiber 110. Each line in the spectra illustrates counts for a different location along the scintillating fiber 110. FIG. 5A illustrates the full spectrum from zero to 20,000 while FIG. 5B illustrates a portion of the spectrum from channels 35 to 125.

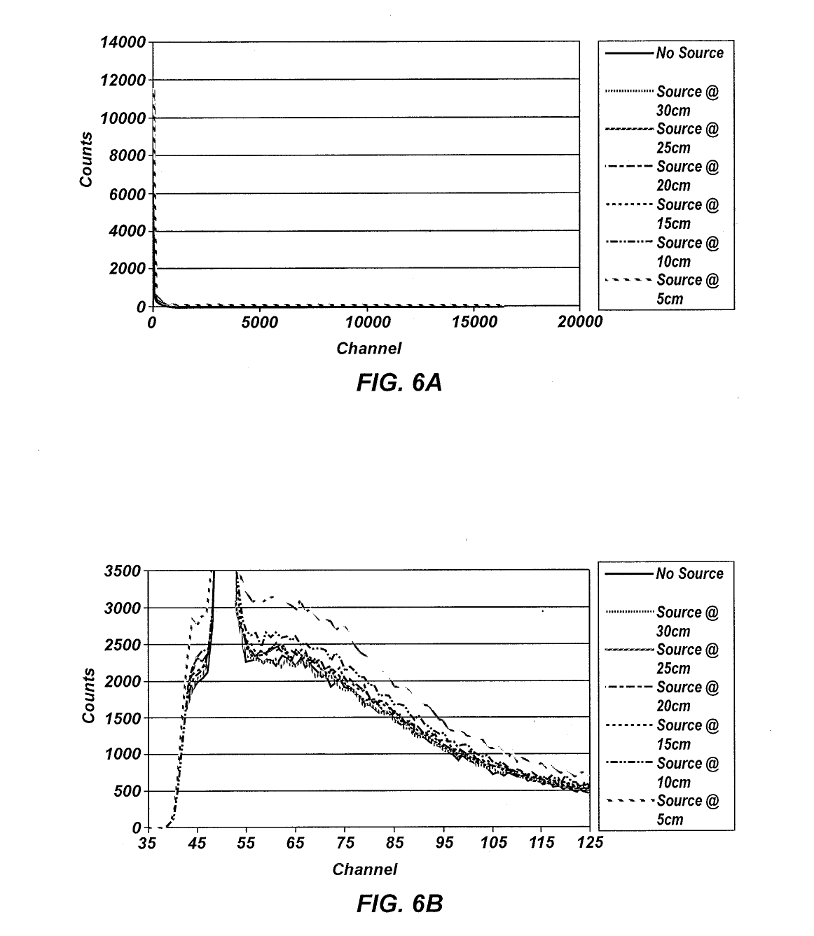

FIGS. 6A and 6B are spectra-graphs showing experimental results for sampling a ⁶⁰Co source with a BCF-10 scintillating fiber 110. Each line in the spectra illustrates counts for a different location along the scintillating fiber 110. FIG. 6A illustrates the full spectrum from zero to 20,000 while FIG. 6B illustrates a portion of the spectrum from channels 35 to 125.

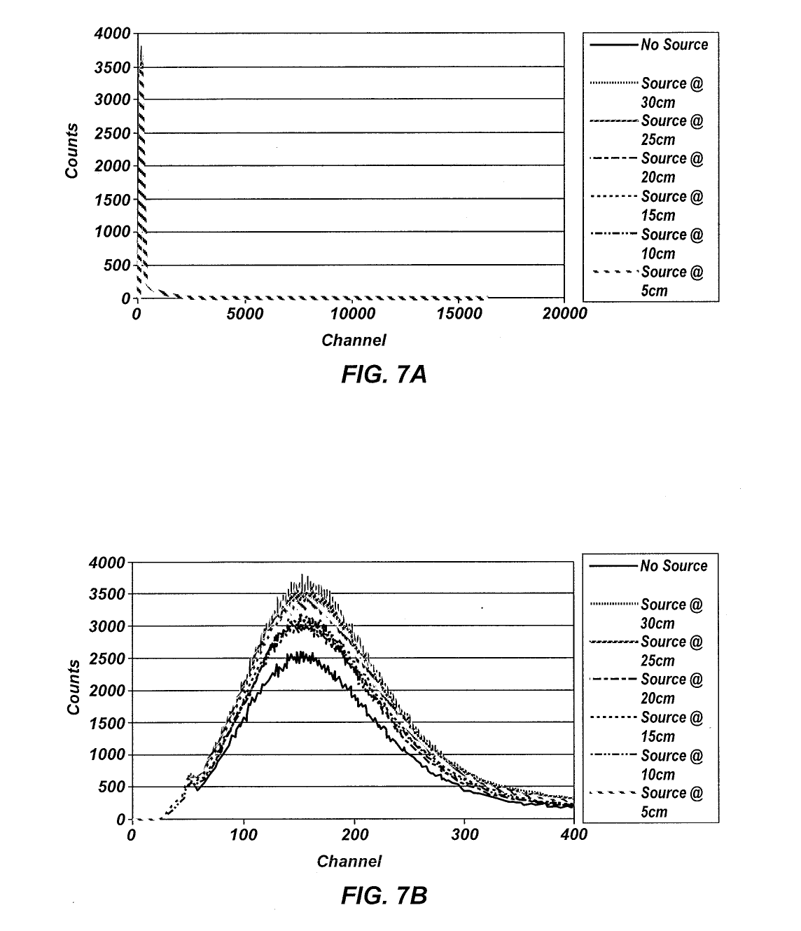

FIGS. 7A and 7B are spectra-graphs showing experimental results for sampling a ²²Na source with a BCF-12 scintillating fibers 110. Each line in the spectra illustrates counts for a different location along the scintillating fiber 110. FIG. 7A illustrates the full spectrum from zero to 20,000 while FIG. 7B illustrates a portion of the spectrum from channels 35 to 125.

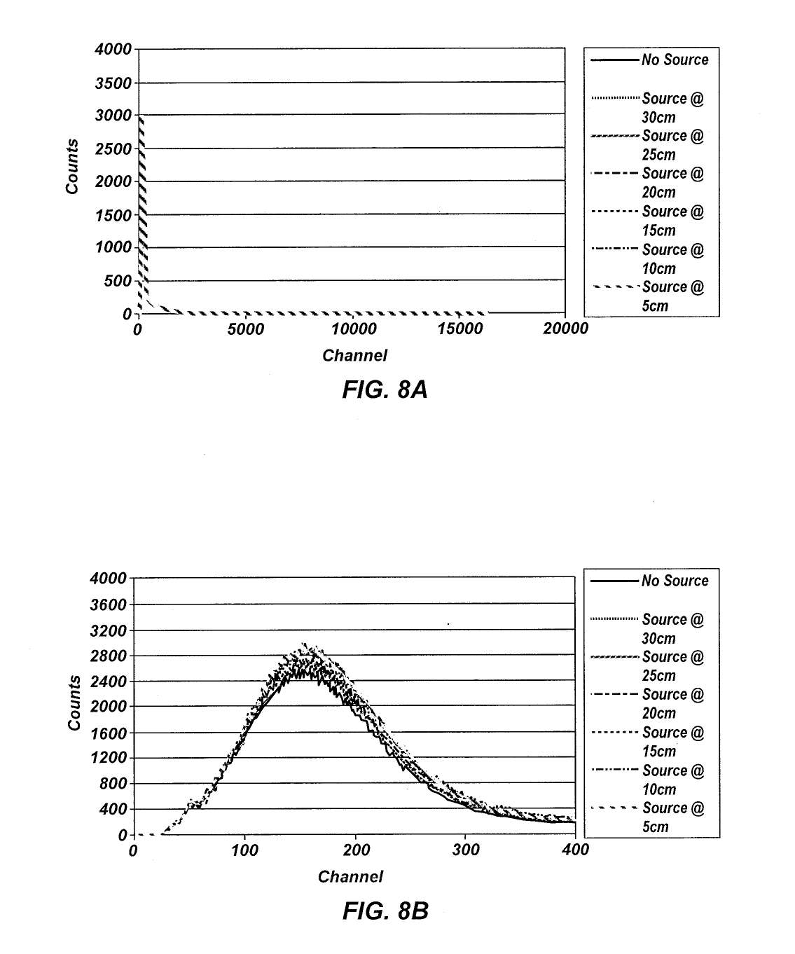

FIGS. 8A and 8B are spectra-graphs showing experimental results for sampling a ¹³⁷Cs source with a BCF-12 scintillating fiber 110. Each line in the spectra illustrates counts for a different location along the scintillating fiber 110. FIG. 8A illustrates the full spectrum from zero to 20,000 while FIG. 8B illustrates a portion of the spectrum from channels 35 to 125.

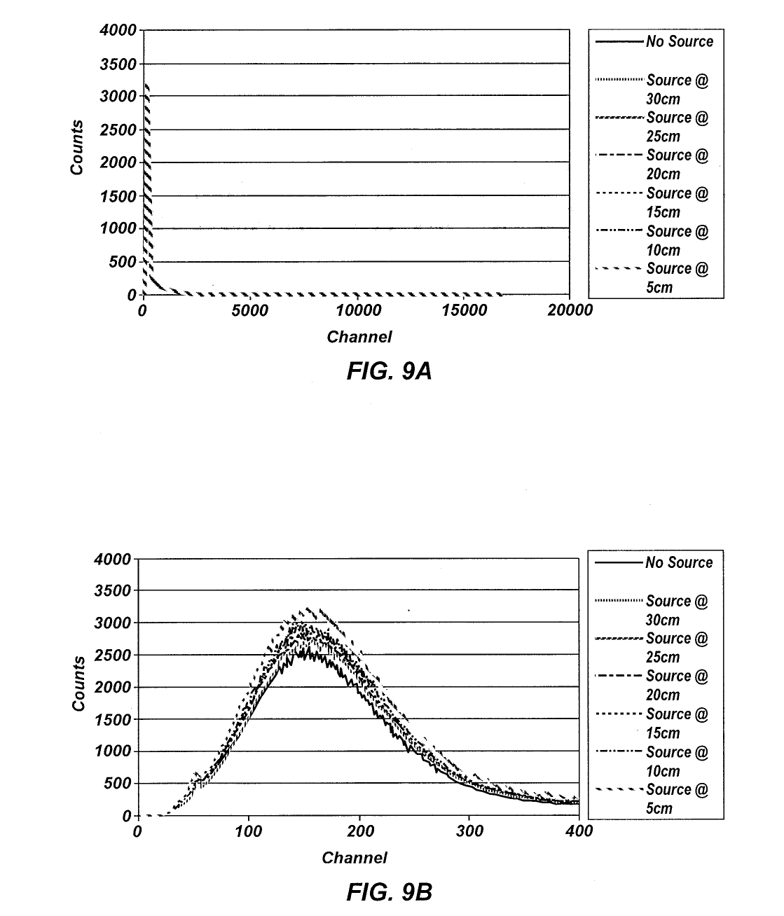

FIGS. 9A and 9B are spectra-graphs showing experimental results for sampling a ⁶⁰Co source with a BCF-12 scintillating fiber 110. Each line in the spectra illustrates counts for a different location along the scintillating fiber 110. FIG. 9A illustrates the full spectrum from zero to 20,000 while FIG. 9B illustrates a portion of the spectrum from channels 35 to 125.

As can be seen from all these spectra, the counts for the BCF-10 fiber spectra increase as the source moves closer to the photon-sensing device 120 (FIG. 1A), located at 0 cm, for all three sources.

For the BCF-12 fiber spectrum, there is less noticeable difference between the counts with or without a source. This may be due to a) the less-optimal match of the emission wavelength of the BCF-12 fiber with the photon-sensing device 120 and b) the thinner diameter of the BCF-12 fiber. The thinner diameter of the BCF-12 fiber may result in less energy deposition per incident beta-particle (the beta-particle ranges in plastic are all longer than 1-mm), thus degrading the signal-to-noise for measurements made with this fiber versus the 1-mm diameter BCF-10.

Because the BCF-10 produced larger results, further research was performed only on the BCF-10 fibers. However, embodiments of the present disclosure may use BCF-12 fibers as well as other suitable scintillating fibers 110. In some embodiments, the thinner fiber may produce more desirable result, such as, for example, in very high rate fields that might lead to a saturation in the thicker fiber. The spectra using the ²²Na source showed the most distinction between the different source locations. As a result, it was decided that this source would be used for the subsequent gross-count analyses. Gross area counts were taken using the ²²Na source and four different bend diameters of the fiber.

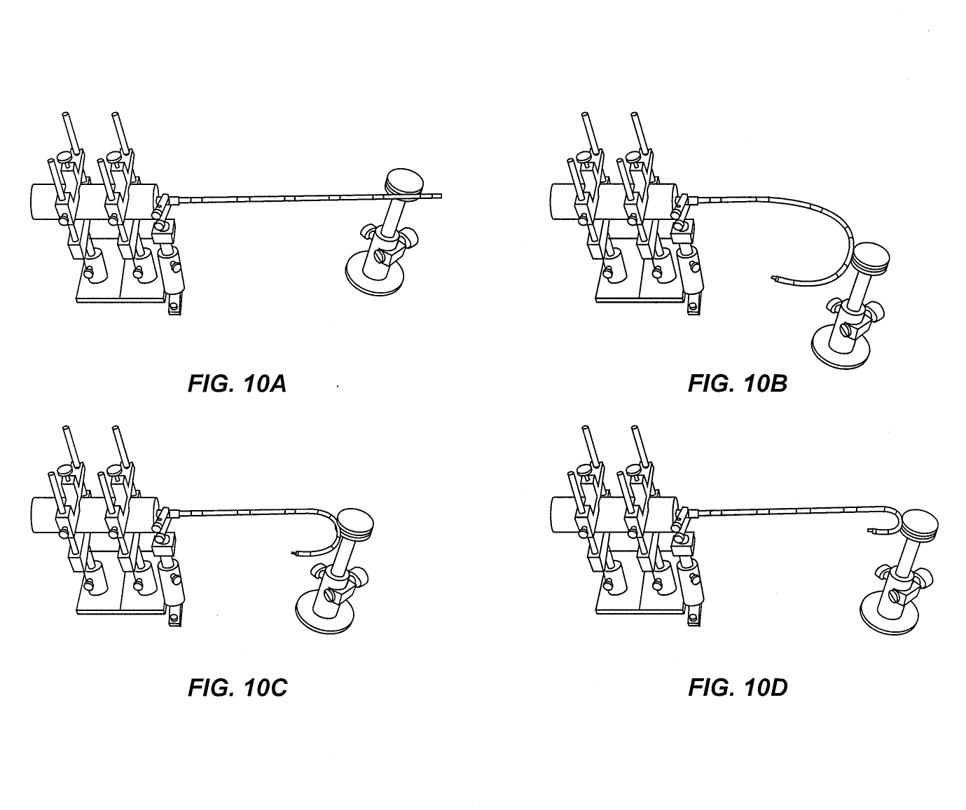

FIGS. 10A through 10D illustrate an experimental test jig for holding a scintillating fiber at various curvatures while sampling a radiation source. FIG. 10A illustrates the scintillating fiber 110 in a straight configuration. FIG. 10B illustrates the scintillating fiber 110 with a diameter of about 110.30 mm. FIG. 10C illustrates the scintillating fiber 110 with a diameter of about 78.62 mm. FIG. 10D illustrates the scintillating fiber 110 with a diameter of about 39.67 mm.

For each of the four fiber orientations, counts were taken with the source in different locations using 900.00-sec count times. The source was moved in 5-cm increments from 5 cm to 30 cm, with separate counts taken at each location. This process was then done two more times. The recorded values are shown in Table 1.

TABLE 1
Recorded Gross Area Values for all Orientations of the BCF-10 Fiber.

| | Fiber Curve | | | | | | | |
|---|---|---|---|---|---|---|---|---|
| | Straight | | D = 110.30 mm | | D = 78.62 mm | | D = 39.67 mm | |
| Dist. | Gross Area | Bkgrnd | Gross Area | Bkgrnd | Gross Area | Bkgrnd | Gross Area | Bkgrnd |
| [cm] | [counts] | [counts] | [counts] | [counts] | [counts] | [counts] | [counts] | [counts] |
| 5 | 12524 | 2353 | 12072 | 2118 | 12057 | 2125 | 12753 | 1937 |
| | 12602 | 3033 | 11899 | 1885 | 11988 | 2116 | 12498 | 1892 |
| | 12294 | 3011 | 11809 | 2010 | 11881 | 2091 | 12838 | 1981 |
| 10 | 12158 | 2353 | 10907 | 2118 | 11396 | 2125 | 12609 | 1937 |
| | 11952 | 3033 | 10798 | 1885 | 11439 | 2116 | 12219 | 1892 |
| | 11972 | 3011 | 10897 | 2010 | 11468 | 2091 | 12335 | 1981 |
| 15 | 9852 | 2353 | 8326 | 2118 | 9135 | 2125 | 9650 | 1937 |
| | 8918 | 3033 | 8374 | 1885 | 8792 | 2116 | 9300 | 1892 |
| | 9220 | 3011 | 8178 | 2010 | 8657 | 2091 | 9497 | 1981 |
| 20 | 8307 | 2353 | 7155 | 2118 | 7186 | 2125 | 8319 | 1937 |
| | 8770 | 3033 | 7114 | 1885 | 7381 | 2116 | 8297 | 1892 |
| | 7893 | 3011 | 7108 | 2010 | 7040 | 2091 | 8044 | 1981 |
| 25 | 6920 | 2353 | 6754 | 2118 | 7109 | 2125 | 6708 | 1937 |
| | 7300 | 3033 | 7147 | 1885 | 6979 | 2116 | 6626 | 1892 |
| | 6585 | 3011 | 7132 | 2010 | 7037 | 2091 | 6821 | 1981 |
| 30 | 4331 | 2353 | 4375 | 2118 | 4314 | 2125 | 3409 | 1937 |
| | 4488 | 3033 | 4150 | 1885 | 4322 | 2116 | 3495 | 1892 |
| | 4259 | 3011 | 4151 | 2010 | 4311 | 2091 | 3398 | 1981 |

A set of equations was then used to perform different calculations on the recorded data.

Equation 1. Calculating the Average of the Gross Area Counts with an Example Using Values for the Straight BCF-10 Fiber at a Distance of 5 cm.

$$Example \text{:} \begin{matrix}gross area average = \frac{gross area 1 + gross area 2 + gross area 3}{3} \\ gross area average = \frac{12524 counts + 12602 counts + 12294 counts}{3} \\ gross area average = 12473.33 counts\end{matrix} \qquad ( 1 )$$

Equation 2. Calculating the Standard Deviation of the Gross Area Counts with an Example Using Values for the Straight BCF-10 Fiber at a Distance of 5 cm.

$$Example \text{:} \begin{matrix}gross area standard deviation = \frac{\sqrt{\begin{matrix}gross area 1 + gross area 2 + \\ gross area 3\end{matrix}}}{3} \\ gross area standard deviation = \frac{\sqrt{\begin{matrix}12524 counts + 12602 counts + \\ 12294 counts\end{matrix}}}{3} \\ gross area standard deviation = 64.48 counts\end{matrix} \qquad ( 2 )$$

Equation 3. Calculating the Average of the Background Counts with an Example Using Values for the Straight BCF-10 Fiber at a Distance of 5 cm.

$$\begin{matrix}Example \text{:} \\ background average = \frac{\begin{matrix}background 1 + \\ background 2 + background 3\end{matrix}}{3} \\ background average = \frac{\begin{matrix}2353 counts + \\ 3033 counts + 3011 counts\end{matrix}}{3} \\ background average = 2799 counts\end{matrix} \qquad ( 3 )$$

Equation 4. Calculating the Standard Deviation of the Background Counts with an Example Using Values for the Straight BCF-10 Fiber at a Distance of 5 cm.

$$Example \text{:} \begin{matrix}background standard deviation = \frac{\sqrt{\begin{matrix}background 1 + \\ background 2 + background 3\end{matrix}}}{3} \\ background standard deviation = \frac{\sqrt{\begin{matrix}2353 counts + \\ 3033 counts + 3011 counts\end{matrix}}}{3} \\ background standard deviation = 30.55 counts\end{matrix} \qquad ( 4 )$$

Equation 5. Calculating the Background Corrected Values for the Gross Area Counts with an Example Using Values for the Straight BCF-10 Fiber at a Distance of 5 cm.

background corrected=gross area average−background average (5)

Example:

background corrected=12473.33 counts−2799 counts

background corrected=9674.33 counts

Equation 6. Calculating the Standard Deviation for the Background Corrected Gross Area Counts with an Example Using Values for the Straight BCF-10 Fiber at a Distance of 5 cm.

background corrected standard deviation=\sqrt{gross area ave.+background ave.} (6)

Example:

background corrected standard deviation=\sqrt{1247.33 counts+2799 counts}

background corrected standard deviation=123.58 counts

The average and standard deviation of all three runs were calculated using Equation 1 and Equation 2, respectively. An average and standard deviation were found at each of the six source locations. The source was then removed and three separate background tests were performed. Equation 3 and Equation 4 were used to find the average and standard deviation of the background counts. The original counts were background corrected using Equation 5. The background corrected standard deviation was then found using Equation 6. Table 2 shows the calculated values for the straight BCF-10 fiber.

TABLE 2
Calculated Values for the Straight BCF-10 Fiber.

| | | | | | | Bkgrnd | | Bkgrnd Crrctd. |
|---|---|---|---|---|---|---|---|---|
| Dist. | Gross Area | Ave. | Std. Dev. | Bkgrnd | Bkgrnd Ave. | Std. Dev. | Bckgnd Crrctd | Std. Dev. |
| [cm] | [counts] | [counts] | [counts] | [counts] | [counts] | [counts] | [counts] | [counts] |
| 5 | 12524 | 12473 | 64 | 2353 | 2799 | 31 | 9674 | 124 |
| | 12602 | | | 3033 | | | | |
| | 12294 | | | 3011 | | | | |
| 10 | 12158 | 12027 | 63 | 2353 | 2799 | 31 | 9228 | 122 |
| | 11952 | | | 3033 | | | | |
| | 11972 | | | 3011 | | | | |
| 15 | 9852 | 9330 | 56 | 2353 | 2799 | 31 | 6531 | 110 |
| | 8918 | | | 3033 | | | | |
| | 9220 | | | 3011 | | | | |
| 20 | 8307 | 8323 | 53 | 2353 | 2799 | 31 | 5224 | 105 |
| | 8770 | | | 3033 | | | | |
| | 7893 | | | 3011 | | | | |
| 25 | 6920 | 6935 | 48 | 2353 | 2799 | 31 | 4136 | 99 |
| | 7300 | | | 3033 | | | | |
| | 6585 | | | 3011 | | | | |
| 30 | 4331 | 4359 | 38 | 2353 | 2799 | 31 | 1560 | 85 |
| | 4488 | | | 3033 | | | | |
| | 4259 | | | 3011 | | | | |

Next, a set of wires was used to fix the fiber with a bend diameter of 110.30 mm at the end of the fiber, shown in FIG. 10B. Gross area counts were taken with 900.00-sec count times using the same process as above. The recorded values can be found in Table 1 above. The same set of calculations was performed with the recorded values for this fiber orientation. The averages and standard deviations of the gross area counts at each location were found using Equation 1 and Equation 2, respectively. New background counts were also taken with this fiber orientation, and the background average and standard deviation were found using Equation 3 and Equation 4, respectively. The original counts were background corrected using Equation 5, and the background corrected standard deviation was found using Equation 6. Table 3 shows the calculated values for the D=110.30 mm BCF-10 fiber.

TABLE 3
Calculated Values for the D = 110.30 mm BCF-10 Fiber.

| | | | | | | Bkgrnd | | Bkgrnd Crrctd. |
|---|---|---|---|---|---|---|---|---|
| Dist. | Gross Area | Ave. | Std. Dev. | Bkgrnd | Bkgrnd Ave. | Std. Dev. | Bckgnd Crrctd | Std. Dev. |
| [cm] | [counts] | [counts] | [counts] | [counts] | [counts] | [counts] | [counts] | [counts] |
| 5 | 12072 | 11927 | 63 | 2118 | 2004 | 26 | 9922 | 118 |
| | 11899 | | | 1885 | | | | |
| | 11809 | | | 2010 | | | | |
| 10 | 10907 | 10867 | 60 | 2118 | 2004 | 26 | 8863 | 113 |
| | 10798 | | | 1885 | | | | |
| | 10897 | | | 2010 | | | | |
| 15 | 8326 | 8293 | 53 | 2118 | 2004 | 26 | 6288 | 101 |
| | 8374 | | | 1885 | | | | |
| | 8178 | | | 2010 | | | | |
| 20 | 7155 | 7126 | 49 | 2118 | 2004 | 26 | 5121 | 96 |
| | 7114 | | | 1885 | | | | |
| | 7108 | | | 2010 | | | | |
| 25 | 6754 | 7011 | 48 | 2118 | 2004 | 26 | 5007 | 95 |
| | 7147 | | | 1885 | | | | |
| | 7132 | | | 2010 | | | | |
| 30 | 4375 | 4225 | 38 | 2118 | 2004 | 26 | 2221 | 79 |
| | 4150 | | | 1885 | | | | |
| | 4151 | | | 2010 | | | | |

Then, a new set of wires was used to fix the fiber with a bend diameter of 78.62 mm at the end of the fiber, shown in FIG. 10C. Gross area counts were taken with 900.00-sec count times using the same process as above. The recorded values can be found in Table 1. The same set of calculations was performed with the recorded values for this fiber orientation. The averages and standard deviations of the gross area counts at each location were found using Equation 1 and Equation 2, respectively. New background counts were also taken with this fiber orientation, and the background average and standard deviation were found using Equation 3 and Equation 4, respectively. The original counts were background corrected using Equation 5, and the background corrected standard deviation was found using Equation 6. Table 4 shows the calculated values for the D=78.62 mm BCF-10 fiber.

TABLE 4
Calculated Values for the D = 78.62 mm BCF-10 Fiber.

| | | | | | | Bkgrnd | | Bkgrnd Crrctd. |
|---|---|---|---|---|---|---|---|---|
| Dist. | Gross Area | Ave. | Std. Dev. | Bkgrnd | Bkgrnd Ave. | Std. Dev. | Bckgnd Crrctd | Std. Dev. |
| [cm] | [counts] | [counts] | [counts] | [counts] | [counts] | [counts] | [counts] | [counts] |
| 5 | 12057 | 11975 | 63 | 2125 | 2111 | 26 | 9865 | 119 |
| | 11988 | | | 2116 | | | | |
| | 11881 | | | 2091 | | | | |
| 10 | 11396 | 11434 | 62 | 2125 | 2111 | 26 | 9324 | 116 |
| | 11439 | | | 2116 | | | | |
| | 11468 | | | 2091 | | | | |
| 15 | 9135 | 8861 | 54 | 2125 | 2111 | 26 | 6751 | 105 |
| | 8792 | | | 2116 | | | | |
| | 8657 | | | 2091 | | | | |
| 20 | 7186 | 7205 | 49 | 2125 | 2111 | 26 | 5092 | 96 |
| | 7381 | | | 2116 | | | | |
| | 7040 | | | 2091 | | | | |
| 25 | 7109 | 7042 | 48 | 2125 | 2111 | 26 | 4931 | 96 |
| | 6979 | | | 2116 | | | | |
| | 7037 | | | 2091 | | | | |
| 30 | 4314 | 4316 | 38 | 2125 | 2111 | 26 | 2205 | 80 |
| | 4322 | | | 2116 | | | | |
| | 4311 | | | 2091 | | | | |

Finally, a third set of wires was used to fix the fiber with a bend diameter of 39.67 mm at the end of the fiber, shown in FIG. 10D. Gross area counts were taken with 900.00-sec count times using the same process as above. The recorded values can be found in Table 1. The same set of calculations was performed with the recorded values for this fiber orientation. The averages and standard deviations of the gross area counts at each location were found using Equation 1 and Equation 2, respectively. New background counts were also taken with this fiber orientation, and the background average and standard deviation were found using Equation 3 and Equation 4, respectively. The counts were background corrected using Equation 5, and the background corrected standard deviation was found using Equation 6. Table 5 shows the calculated values for the D=39.67 mm BCF-10 fiber.

TABLE 5
Calculated Values for the D = 39.67 mm BCF-10 Fiber.

| | | | | | | Bkgrnd | | Bkgrnd Crrctd. |
|---|---|---|---|---|---|---|---|---|
| Dist. | Gross Area | Ave. | Std. Dev. | Bkgrnd | Bkgrnd Ave. | Std. Dev. | Bckgnd Crrctd | Std. Dev. |
| [cm] | [counts] | [counts] | [counts] | [counts] | [counts] | [counts] | [counts] | [counts] |
| 5 | 12753 | 12696 | 65 | 1937 | 1937 | 25 | 10760 | 121 |
| | 12498 | | | 1892 | | | | |
| | 12838 | | | 1981 | | | | |
| 10 | 12609 | 12388 | 64 | 1937 | 1937 | 25 | 10451 | 120 |
| | 12219 | | | 1892 | | | | |
| | 12335 | | | 1981 | | | | |
| 15 | 9650 | 9842 | 56 | 1937 | 1937 | 25 | 7546 | 107 |
| | 9300 | | | 1892 | | | | |
| | 9497 | | | 1981 | | | | |
| 20 | 8319 | 8220 | 52 | 1937 | 1937 | 25 | 6283 | 101 |
| | 8297 | | | 1892 | | | | |
| | 8044 | | | 1981 | | | | |
| 25 | 6708 | 6718 | 47 | 1937 | 1937 | 25 | 4782 | 93 |
| | 6626 | | | 1892 | | | | |
| | 6821 | | | 1981 | | | | |
| 30 | 3409 | 3433 | 34 | 1937 | 1937 | 25 | 1497 | 73 |
| | 3495 | | | 1892 | | | | |
| | 3398 | | | 1981 | | | | |

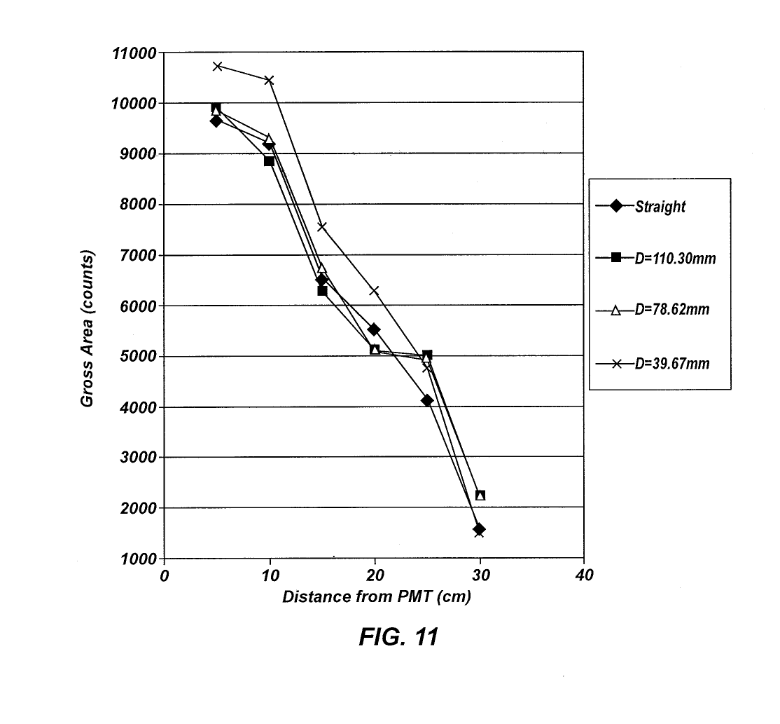

FIG. 11 shows a graph of all of the background corrected averages with standard deviation as a function of distance from the photon-sensing device 120. As shown in the graph, the change in fingertip dose rate was repeatable.

A second round of tests was performed to double-check the measured values. During these tests, the source was only placed at 5 cm, 15 cm, and 30 cm. The fiber was still tested with the four different orientations, but each test was only performed once (instead of the previous three times to find an average). These counts were also background corrected using Equation 5. The recorded values for the double-check test can be found in Table 6. Graph 14 shows the results of these tests.

TABLE 6
Recorded Double-Check Gross Area Values for all Orientations of the BCF-10 Fiber.

| | Fiber Curve | | | | | | | |
|---|---|---|---|---|---|---|---|---|
| | Straight | | D = 110.30 mm | | D = 78.62 mm | | D = 39.67 mm | |
| Dist. | Gross Area | Bkgrnd | Gross Area | Bkgrnd | Gross Area | Bkgrnd | Gross Area | Bkgrnd |
| [cm] | [counts] | [counts] | [counts] | [counts] | [counts] | [counts] | [counts] | [counts] |
| 5 | 13044 | 2842 | 12585 | 2169 | 12293 | 2254 | 12514 | 2171 |
| 15 | 10749 | 2842 | 10076 | 2169 | 9719 | 2254 | 10226 | 2171 |
| 30 | 3295 | 2842 | 3214 | 2169 | 3247 | 2254 | 3307 | 2171 |

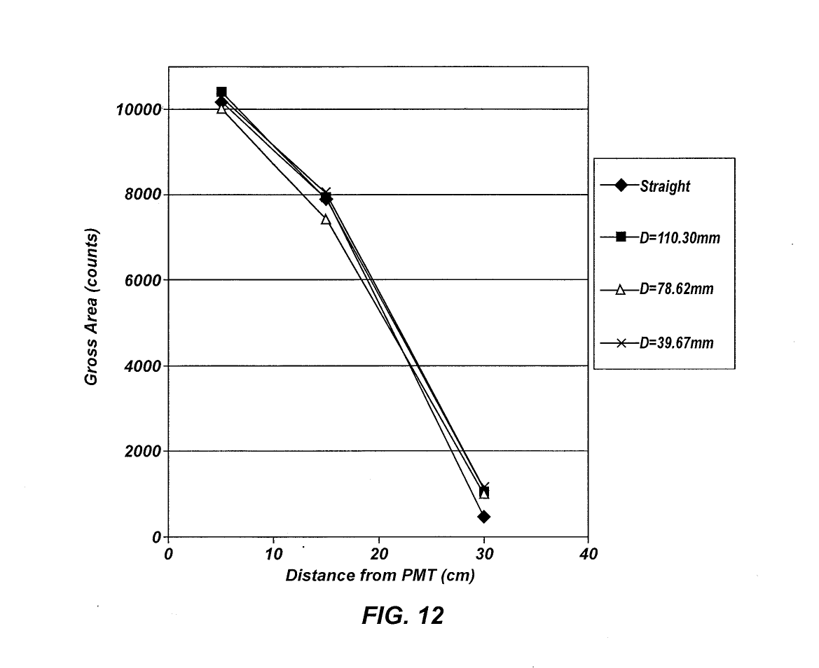

FIG. 12 shows a graph of all of the background corrected averages with standard deviation as a function of distance from the photon-sensing device 120 from a second round of tests. After these tests were performed, a slight downward slope of the scintillating fiber 110 was noticed. Since the source was kept at a constant height throughout the entire experiment, this slope meant that the small gap between the source and fiber at a distance of 5 cm increased as the source moved down the wire, creating a larger gap between the source and the fiber at a distance of 30 cm. This larger gap accounts for the unexpected sharp decrease in gross area counts, in both the original and double-check data, at a distance of 30 cm. A third round of tests was performed with the scintillating fiber 110 straight, ensuring that the surface of the source-shield combination was always one mm away from the fiber. This data was then used to normalize the original data.

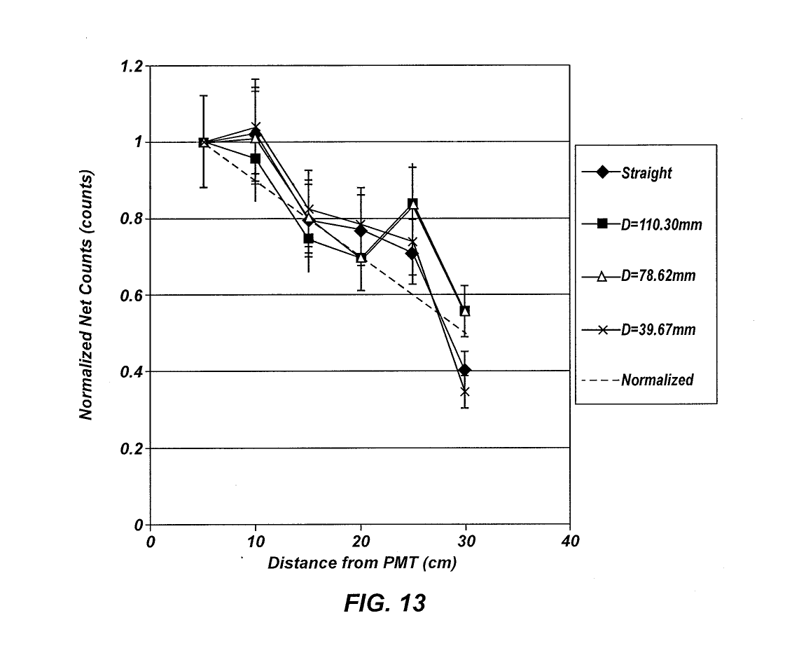

FIG. 13 illustrates the normalized data from a third round of tests on the straight scintillating fiber 110. It was found that there was no noticeable difference in the counts at a distance of 30 cm between the different fiber orientations. It was determined that the fingertip dose rate can be conservatively bounded by maximum attenuation. This finding means that there will be little or no discernible restriction on how much the finger can bend. Moreover, some embodiments of the present disclosure reduce the change of a kink developing in the fiber when a finger bends by allowing the fibers to move freely within the sleeves.

Dose measurements were performed on several other sources. These additional measurements were performed in order to determine a conversion factor to get the dose from the counts seen from the scintillating fiber 110. The sources tested were a ⁶⁰Co disk source, a ¹³⁷Cs disk source, a ²²Na disk source, a Californium-252 (²⁵²Cf) disk source, a ²⁵²Cf cylinder, a strontium-90 (⁹⁰Sr) disk source, an Americium-241 (²⁴¹Am) disk source, and a thorium (Th) rod. Each source was tested using beta-corrected measurements and gamma measurements at contact as well as at 30 cm. Each disk source had each test performed with the labeled side toward the detector and also with the non-labeled side toward the detector. The cylinder was tested on the bottom and the side. The Th rod was only tested in the center of the rod.

Beta-corrected dose measurements were performed with a calibrated beta-gamma health-physics meter. Measurements were taken first with the window open and then with the window closed. Equation 7 was used to calculate the beta-corrected dose value. Equation 7. Beta-Corrected Dose Equation with an Example Using the Labeled Side of the ²²Na Source at Contact.

$$Example \text{:} \\ β corrected = [ 3 ( open window - closed window ) ] + closed window \\ β corrected = [ 3 ( 90 \frac{m rad}{h} - 7 \frac{m rad}{h} ) ] + 7 \frac{m rad}{h} \\ β corrected = 256 \frac{m rad}{h} \qquad ( 7 )$$

The beta-corrected measurements recorded from all eight sources at contact can be seen in Table 7, where “labeled side” also refers to the bottom of the ²⁵²Cf cylinder and the center of the Th rod and “non-labeled side” also refers to the side of the ²⁵²Cf cylinder.

TABLE 7
Beta-Corrected Values at Contact.

| | | | |
|---|---|---|---|
| | open window | closed window | value |
| source | [mrad/h] | [mrad/h] | [mrad/h] |

A) Labeled Side

| | | | |
|---|---|---|---|
| ⁶⁰Co | 7 | 3.6 | 13.8 |
| ¹³⁷Cs | 22 | 1.7 | 62.6 |
| ²²Na | 90 | 7 | 256 |
| ²⁵²Cf disk | 0.1 | 0 | 0.3 |
| ²⁵²Cf cylinder | 2.1 | 1.3 | 3.7 |
| ⁹⁰Sr | 0.2 | 0.05 | 0.5 |
| ²⁴¹Am | 0.05 | 0 | 0.15 |
| Th rod | 0.15 | 0.05 | 0.35 |

B) Non-Labeled Side

| | | | |
|---|---|---|---|
| ⁶⁰Co | 4.5 | 3.1 | 7.3 |
| ¹³⁷Cs | 1.8 | 1.35 | 2.7 |
| ²²Na | 8 | 5.5 | 13 |
| ²⁵²Cf disk | 0.05 | 0 | 0.15 |
| ²⁵²Cf cylinder | 1.25 | 0.8 | 2.15 |
| ⁹⁰Sr | 31 | 0.05 | 92.9 |
| ²⁴¹Am | 0.2 | 0.05 | 0.5 |
| Th rod | n/a | n/a | n/a |

The beta-corrected measurements recorded from all eight sources at a distance of 30 cm can be seen in Table 8, where “labeled side” also refers to the bottom of the ²⁵²Cf cylinder and the center of the Th rod and “non-labeled side” also refers to the side of the ²⁵²Cf cylinder.

TABLE 8
Beta-Corrected Values at 30 cm.

| | | | |
|---|---|---|---|
| | open window | closed window | value |
| source | [mrad/h] | [mrad/h] | [mrad/h] |

A) Labeled Side

| | | | |
|---|---|---|---|
| ⁶⁰Co | 0.2 | 0.1 | 0.4 |
| ¹³⁷Cs | 0.35 | 0.1 | 0.85 |
| ²²Na | 0.8 | 0.15 | 2.1 |
| ²³²Cf disk | 0.05 | 0 | 0.15 |
| ²⁵²Cf cylinder | 0.15 | 0.1 | 0.25 |
| ⁹⁰Sr | 0.1 | 0.05 | 0.2 |
| ²⁴¹Am | 0.1 | 0.05 | 0.2 |
| Th rod | 0.1 | 0.05 | 0.2 |

B) Non-Labeled Side

| | | | |
|---|---|---|---|
| ⁶⁰Co | 0.15 | 0.1 | 0.25 |
| ¹³⁷Cs | 0.1 | 0.05 | 0.2 |
| ²²Na | 0.2 | 0.15 | 0.3 |
| ²⁵²Cf disk | 0.05 | 0 | 0.15 |
| ²⁵²Cf cylinder | 0.15 | 0.1 | 0.25 |
| ⁹⁰Sr | 0.5 | 0.05 | 1.4 |
| ²⁴¹Am | 0.1 | 0.05 | 0.2 |
| Th rod | n/a | n/a | n/a |

Gamma-ray dose measurements were also performed with a calibrated gamma-ray ionization meter. An initial background measurement was taken, and then measurements were taken with the detector. Equation 8 was used to calculate the gamma dose value. Equation 8. Gamma Dose Equation with an Example Using the Labeled Side of the ²²Na Source at Contact.

$$Example \text{:} \\ γ = measurement - background \\ γ = 30 , 000 \frac{µrem}{h} - 10 \frac{µrem}{h} \\ γ = 29 , 900 \frac{µrem}{h} \qquad ( 8 )$$

The gamma measurements recorded from all eight sources at contact can be seen in Table 9, where “labeled side” also refers to the bottom of the ²⁵²Cf cylinder and the center of the Th rod and “non-labeled side” also refers to the side of the ²⁵²Cf cylinder.

TABLE 9
Gamma Values at Contact.

| | | | |
|---|---|---|---|
| | Bkgrnd | Msrmnt | value |
| source | [μrem/h] | [μrem/h] | [μrem/h] |

A) Labeled Side

| | | | |
|---|---|---|---|
| ⁶⁰Co | 10 | 14000 | 13990 |
| ¹³⁷Cs | 10 | 6500 | 6490 |
| ²²Na | 10 | 30000 | 29990 |
| ²⁵²Cf disk | 10 | 18 | 8 |
| ²⁵²Cf cylinder | 10 | 6000 | 5990 |
| ⁹⁰Sr | 10 | 14 | 4 |
| ²⁴¹Am | 10 | 25 | 15 |
| Th rod | 10 | 110 | 100 |

B) Non-Labeled Side

| | | | |
|---|---|---|---|
| ⁶⁰Co | 10 | 10500 | 10490 |
| ¹³⁷Cs | 10 | 4500 | 4490 |
| ²²Na | 10 | 18000 | 17990 |
| ²⁵²Cf disk | 10 | 35 | 25 |
| ²⁵²Cf cylinder | 10 | 2000 | 1990 |
| ⁹⁰Sr | 10 | 850 | 840 |
| ²⁴¹Am | 10 | 140 | 130 |
| Th rod | n/a | n/a | n/a |

The gamma measurements recorded from all eight sources at a distance of 30 cm can be seen in Table 10, where “labeled side” also refers to the bottom of the 252Cf cylinder and the center of the Th rod and “non-labeled side” also refers to the side of the 252Cf cylinder.

TABLE 10
Gamma Values at 30 cm.

| | | | |
|---|---|---|---|
| | Bkgrnd | Msrmnt | value |
| source | [μrem/h] | [μrem/h] | [μrem/h] |

A) A Labeled Side

| | | | |
|---|---|---|---|
| ⁶⁰Co | 10 | 60 | 50 |
| ¹³⁷Cs | 10 | 40 | 30 |
| ²²Na | 10 | 130 | 120 |
| ²⁵²Cf disk | 10 | 11 | 1 |
| ²⁵²Cf cylinder | 10 | 30 | 20 |
| ⁹⁰Sr | 10 | 12 | 2 |
| ²⁴¹Am | 10 | 11 | 1 |
| Th rod | 10 | 10.5 | 0.5 |

B) Non-Labeled Side

| | | | |
|---|---|---|---|
| ⁶⁰Co | 10 | 60 | 50 |
| ¹³⁷Cs | 10 | 35 | 25 |
| ²²Na | 10 | 115 | 105 |
| ²⁵²Cf disk | 10 | 15 | 5 |
| ²⁵²Cf cylinder | 10 | 30 | 20 |
| ⁹⁰Sr | 10 | 12 | 2 |
| ²⁴¹Am | 10 | 11.5 | 1.5 |
| Th rod | n/a | n/a | n/a |

B) Note: The on-contact gamma-ray dose rate readings taken with the beta/gamma-ray ionization chamber (Table 7) are approximately 4 times less than those recorded using the gamma-ray ionization chamber (Table 9). This discrepancy may be due to several factors including a) variations in placement of the detectors for the on-contact measurements, b) variations in the scaling calibration factors for the two instruments, and c) the likely contribution of beta-induced bremsstrahlung within the gamma-ray ionization chamber. Comparing the longer stand-off measurements at 30 cm, the two instruments were found to report values consistent within their measurement precision. For the determination of a generic beta/gamma-ray conversion factor for ²²Na, the beta-particle contributes a much larger fraction to the total measurement value, diminishing the impact of the gamma-ray measurement variations in these two instruments.
C) In order to know the dose received from the counts recorded, a conversion factor may be used. As a non-limiting example, the labeled side of the ²²Na source was used while conducting tests with the scintillating fiber 110, and the source was almost at contact with the scintillating fiber 110, so the beta-corrected value for the labeled side of the ²²Na source at contact was used to find the conversion factor. The tips of the fingers may be of the greatest concern, so the counts at a distance of 30 cm were used to find the conversion factor. By setting the background corrected counts at 30 cm for each fiber orientation equal to the beta-corrected value for the labeled side of the ²²Na source at contact, the conversion factors for each orientation can be found. Equation 9 through Equation 12 show the conversion factor calculations for each fiber orientation.
D) Equation 9. Conversion Factor for the Straight Fiber.

$$\frac{1560.3333 counts}{900 s} = 256 \frac{m rad}{h} \\ 1560.3333 counts = 230400 \frac{m rad}{h} \\ 1560.3333 counts = 64 m rad \\ 100 counts = 4.101 m rad \qquad ( 9 )$$

E) Equation 10. Conversion Factor for the D=110.30 mm Fiber.

$$\frac{2221 counts}{900 s} = 256 \frac{m rad}{h} \\ 2221 counts = 230400 \frac{m rad}{h} \\ 2221 counts = 64 m rad \\ 100 counts = 2.88 m rad \qquad ( 10 )$$

F) Equation 11. Conversion Factor for the D=78.62 mm Fiber.

$$\frac{2205 counts}{900 s} = 256 \frac{m rad}{h} \\ 2205 counts = 230400 \frac{m rad}{h} \\ 2205 counts = 64 m rad \\ 100 counts = 2.902 m rad \qquad ( 11 )$$

G) Equation 12. Conversion Factor for the D=39.67 mm Fiber.

$$\frac{1497.3333 counts}{900 s} = 256 \frac{m rad}{h} \\ 1497.3333 counts = 230400 \frac{m rad}{h} \\ 1497.3333 counts = 64 m rad \\ 100 counts = 4.274 m rad \qquad ( 12 )$$

H) In order to be conservative, the maximum value found for any orientation of the fiber will be used. The maximum value was found using the D=39.67 mm fiber, making 100 counts equal 4.274 mrad.
I) While the present disclosure may be susceptible to various modifications and alternative forms, specific embodiments have been shown by way of example in the drawings and have been described in detail herein; however, it should be understood that the disclosure is not limited to the particular forms disclosed. Rather, the disclosure includes all modifications, equivalents, legal equivalents, and alternatives falling within the scope of the disclosure as defined by the following appended claims.

What is claimed is:

1. A radiation monitoring system, comprising:
one or more scintillating fibers for generating photons responsive to exposure to radiation in proximity to one or more of a length and a proximate end of the one or more scintillating fibers;
a photon-sensing device operably coupled to a distal end of each of the one or more scintillating fibers for sensing photons from the one or more scintillating fibers;
an extremity protection device comprising:
one or more individual fiber sleeves, each individual fiber sleeve for holding a corresponding one of the one or more scintillating fibers substantially close to a an extremity; and
a collector pocket for holding the photon-sensing device substantially near the extremity.

2. The radiation monitoring system of claim 1, wherein the extremity protection device comprises a glove to be worn on a hand of a person such that each of the one or more scintillating fibers is held substantially close to a finger of the glove and the corresponding proximate end is held substantially near a fingertip of the glove.

3. The radiation monitoring system of claim 1, wherein the photon-sensing device comprises a photomultiplier tube.

4. The radiation monitoring system of claim 1, wherein the photon-sensing device comprises one or more photodiodes.

5. The radiation monitoring system of claim 1, wherein the photon sensing device is operably coupled to a distal end of a plurality of the one or more scintillating fibers for sensing photons from the plurality of the one or more scintillating fibers.

6. The radiation monitoring system of claim 1, wherein the photon-sensing device is configured for generating an electrical signal responsive to the sensed photons and the radiation dose monitoring system further comprises:
a photon signal analyzer operably coupled to the photon-sensing device and configured to generate a dose signal responsive to an analysis of the electrical signal; and
a dose indicator for presenting a warning to a user responsive to the dose signal.

7. The radiation monitoring system of claim 6, wherein the dose indicator is configured to indicate a dose rate above a predetermined threshold.

8. The radiation monitoring system of claim 6, wherein the dose indicator is configured to indicate a cumulative dose above a predetermined threshold.

9. The radiation monitoring system of claim 6, wherein the photon signal analyzer further comprises:
a discriminator operably coupled to the photon-sensing device; and
a multi-channel analyzer operably coupled to the discriminator, wherein the multi-channel analyzer is configured to generate the dose signal.

10. The radiation monitoring system of claim 9, wherein the discriminator comprises a constant fraction discriminator.

11. The radiation monitoring system of claim 6, further comprising a computing system operably coupled to the photon signal analyzer and wherein the computing system and the photon signal analyzer are cooperatively associated to perform the analysis of the electrical signal to generate the dose signal.

12. The radiation monitoring system of claim 11, wherein the photon signal analyzer and the computing system are wirelessly communicable.

13. A method of monitoring a radiation, the method comprising:
sensing radiation proximate a glove on a hand of a person with one or more scintillating fibers held by one or more individual fiber sleeves, each individual fiber sleeve disposed on a corresponding finger of the glove;
generating photons responsive to the one or more scintillating fibers exposure to the radiation;
generating an electrical signal with a photon-sensing device held on a forearm portion of the glove responsive to the sensed photons; and
evaluating a radiation dose level responsive to the electrical signal.

14. The method of claim 13, further comprising presenting a dose indicator to a user responsive to the evaluating the radiation dose level.

15. The method of claim 14, wherein presenting the dose indicator comprises presenting a dose rate above a predetermined threshold.

16. The method of claim 14, presenting the dose indicator comprises presenting a cumulative dose above a predetermined threshold.

17. The method of claim 14, further comprising:
performing a discrimination on the electrical signal; and
processing the electrical signal with a multi-channel analyzer to perform the evaluating the radiation level.

18. A radiation monitoring glove, comprising:
a glove adapted to be worn by a person;
one or more fiber sleeves attached to one or more fingers of the glove;
one or more scintillating fibers disposed at least in part in the one or more fiber sleeves, the one or more scintillating fibers configured for generating photons responsive to exposure to radiation in proximity thereto;
a photon-sensing device disposed in a collector pocket on the glove and operably coupled to a distal end of the one or more scintillating fibers.

19. The radiation monitoring glove of claim 18, wherein the one or more fiber sleeves are adapted and positioned to enable the one or more scintillating fibers to slide freely therein as the one or more fingers of the glove move.

20. The radiation monitoring glove of claim 18, further comprising a dose indicator disposed on the glove and configured for notifying the person wearing the glove of an anomalous dose indicated by a dose signal received by the dose indicator.

21. The radiation monitoring glove of claim 20, further comprising a photon signal analyzer operably coupled to the photon-sensing device, disposed in the collector pocket, and configured for generating the dose signal.

22. The radiation monitoring glove of claim 20, wherein the dose indicator indicates at least one of a total dosage and a dose rate.

23. The radiation monitoring glove of claim 18, further comprising a photon signal analyzer operably coupled to the photon-sensing device, disposed in the collector pocket, and configured for analyzing an electrical signal from the photon-sensing device.

24. The radiation monitoring glove of claim 18, wherein:
the one or more fiber sleeves comprises multiple fiber sleeves with one or more fiber holder attached to each of five fingers of the gloves;
the one or more scintillating fibers comprises multiple scintillating fibers, one or more associated with each of the multiple fiber sleeves; and
the photon-sensing device is operably coupled to the distal ends of each of the five scintillating fibers.

25. The radiation monitoring glove of claim 24, further comprising a fiber collector attached to the glove near a wrist portion and on a back-of-hand side of the glove for collecting the multiple scintillating fibers together before reaching the collector pocket.

26. The radiation monitoring glove of claim 24, further comprising a fiber collector attached to the glove near a wrist portion and on a palm side of the glove for collecting the multiple scintillating fibers together before reaching the collector pocket.

27. The radiation monitoring glove of claim 24, wherein the fiber sleeves are disposed on a palm side of the glove.

28. The radiation monitoring glove of claim 24, wherein the fiber sleeves are disposed on a back-of-hand side of the glove.

29. The radiation monitoring glove of claim 24, wherein each of the five fiber sleeves are disposed on a side of a finger of the glove.

30. The radiation monitoring glove of claim 24, wherein at least one of the one or more fiber sleeves includes more than one of the one or more scintillating fibers disposed therein.
